(19) United States
(12) Patent Application Publication
(10) Pub. No.: US 2015/0015526 A1
(43) Pub. Date: Jan. 15, 2015

(54) TOUCH SCREEN

(71) Applicants: Zhenzhong Wang, Quanzhou (CN); Cheohui Lin, Quanzhou (CN); Hao Ning, Wappingers Falls, NY (US)

(72) Inventors: Zhenzhong Wang, Quanzhou (CN); Cheohui Lin, Quanzhou (CN); Hao Ning, Wappingers Falls, NY (US)

(21) Appl. No.: 13/937,235

(22) Filed: Jul. 9, 2013

(51) Int. Cl. G06F 3/044

(52) U.S. Cl. CPC G06F 3/044
USPC 345/174

(57) ABSTRACT

A touch screen contains a capacitive sensing layer, a first controller for detecting a touching position, a piezoelectric sensing layer, a second controller for detecting a touching pressure, and a main controller. The touch screen also comprises a window area and a non-window area, the capacitive sensing layer is arranged in the window area, the piezoelectric sensing layer is arranged in the non-window area. The first controller connects with the capacitive sensing layer, the second controller couples with the piezoelectric sensing layer, and the main controller is in connection with the first controller and the second controller. The first controller transmits a touching signal of the capacitive sensing layer to the main controller, and the second controller transmits a pressing signal of the piezoelectric sensing layer to the main controller, such that the main controller acquires the touching position and the pressure value on the touch screen.

### FIELD OF THE INVENTION

The present invention relates to a touch screen which allows sensing the touching position and the pressure value on the touch screen sensitively.

### BACKGROUND OF THE INVENTION

A conventional touch panel disclosed in CN Patent No. 201080025407.X contains a transparent polylactic acid film covered on a touch screen and divided into plural electrodes, wherein each electrode is severed to detect a touching position and a troucing pressure. But a piezoelectric coefficient of the polylactic acid film is around 20PC/N, a thickness of the polylactic acid film has to be therefore increased so as to enhance detecting sensitivity.

However, the thicker the polylactic acid film is, the lower transmittance is.

Also, a touch-sensitive system and method for controlling the operation thereof is disclosed in US 20120162142 and has light-emitting elements disposed on peripheral sides of glass so as to project infrared light to a glass cover and has photosensitive elements for detecting infrared lights which are transmitted to the glass cover. Nevertheless, since many light-emitting elements and hotosensitive elements are provided on the peripheral sides of the glass, the touch screen has a large size.

In addition, a display method and system of an inputting method is disclosed in CN Patent No. 201210154672.9, by which, a plurality of pressure sensors are mounted on four peripheral sides of a cellphone so as to sense pressing state when two vertical peripheral sides of the cellphone are pressed, such that plurality of pressure sensors can distinguish the cellphone is held by a left hand or a right hand, thus optimizing an input display. Thereby, a difference of pressures forced on the two vertical peripheral sides of the cellphone is detected. Yet a touching pressure forced on a panel of the cellphone by fingers cannot be detected.

The present invention has arisen to mitigate and/or obviate the afore-described disadvantages.

### SUMMARY OF THE INVENTION

The primary object of the present invention is to provide a touch screen which allows sensing the touching position and the pressure value sensitively.

Another object of the present invention is to provide a touch screen which is simplified its structure and decrease its size.

To obtain the above objectives, a touch screen contains a capacitive sensing layer, a first controller for detecting a touching position, a piezoelectric sensing layer, a second controller for detecting a touching pressure, and a main controller.

The touch screen also comprises a window area and a non-window area, the capacitive sensing layer is arranged in the window area, the piezoelectric sensing layer is arranged in the non-window area. The first controller connects with the capacitive sensing layer, the second controller couples with the piezoelectric sensing layer, and the main controller is in connection with the first controller and the second controller. The first controller transmits a touching signal of the capacitive sensing layer to the main controller, and the second controller transmits a pressing signal of the piezoelectric sensing layer to the main controller, such that the main controller acquires the touching position and the pressure value on the touch screen.

Thereby, a transmittance of the piezoelectric sensing layer is less than 80%, so the piezoelectric sensing layer is arranged in the non-window area of the touch screen, and the capacitive sensing layer is arranged in the window area so as to detect the touching position in X, Y axes, and the piezoelectric sensing layer detects the pressure value on the piezoelectric sensing layer of the touch screen in Y axis, thereafter an electrical charge of a pressure point of the piezoelectric sensing layer and a capacitor sensed by the capacitive sensing layer are inputted into the first controller and the second controller so as to be processed and calculated, wherein the first controller and the second controller allow converting charge voltage and outputting digital signals, such as the touching position, the pressure value, and touch time. Thereafter, the digital signals are transmitted to the main controller from the first controller and the second controller, such that the main controller acquires the touching position and the pressure value on the touch screen, thus obtaining three-dimensional interface control and human-computer interaction based on the pressure value.

### BRIEF DESCRIPTION OF THE DRAWINGS

FIG. 1 is a plan view of a touch screen according to a first embodiment of the present invention.

FIG. 2 is another plan view of the touch screen according to the first embodiment of the present invention.

FIG. 3 is a cross sectional view taken along the lines I-I of FIG. 2.

FIG. 4 is diagram showing the structure of the touch screen according to the first embodiment of the present invention.

FIG. 5 is a plan view of a touch screen according to a second embodiment of the present invention.

FIG. 6 is a plan view of a touch screen according to a third embodiment of the present invention.

FIG. 7 is a plan view of a touch screen according to a fourth embodiment of the present invention.

FIG. 8 is a plan view of a touch screen according to a fifth embodiment of the present invention.

### DETAILED DESCRIPTION OF THE PREFERRED EMBODIMENTS

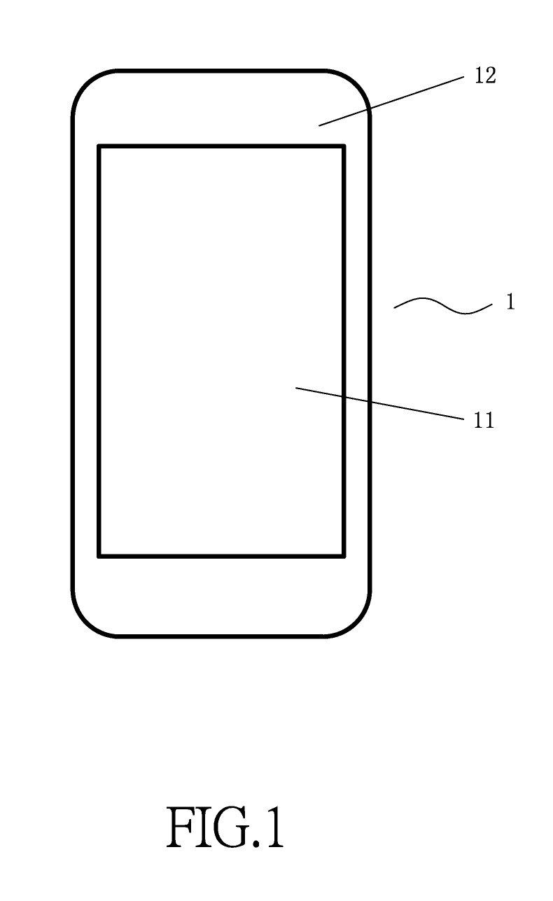

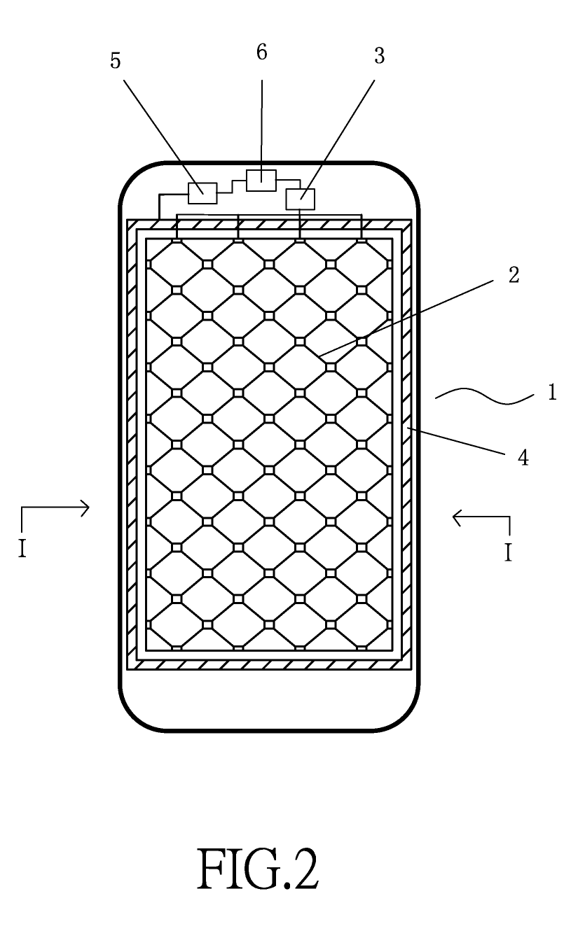

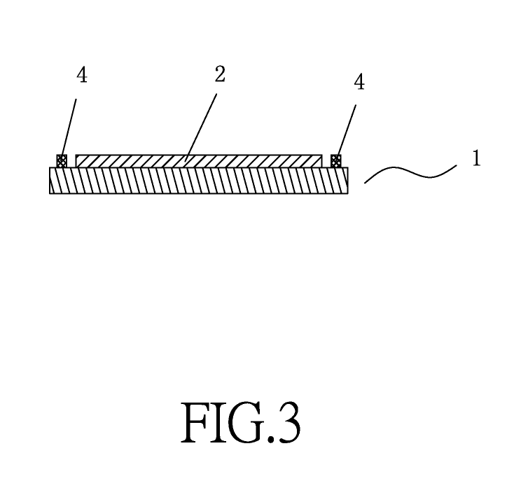

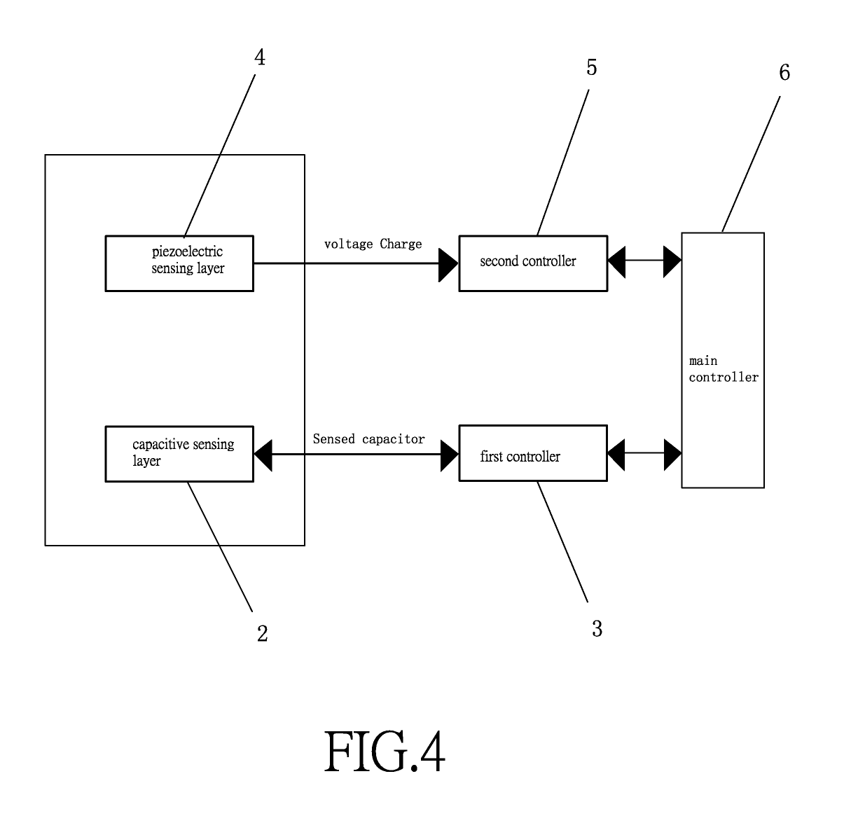

Referring further to FIGS. 1-4, a touch screen 1 according to a first embodiment of the present invention comprises: a capacitive sensing layer 2, a first controller 3 for detecting a touching position on the capacitive sensing layer 2, a piezoelectric sensing layer 4, a second controller 5 for detecting a touching pressure on the capacitive sensing layer 2, and a main controller 6.

The touch screen 1 also comprises a window area 11 and a non-window area 12. The capacitive sensing layer 2 is arranged in the window area 11, the piezoelectric sensing layer 4 is arranged in the non-window area 12, and the first controller 3 connects with the capacitive sensing layer 2, the second controller 5 couples with the piezoelectric sensing layer 4, and the main controller 6 is in connection with the first controller 3 and the second controller 5, wherein the first controller 3 transmits a touching signal of the capacitive sensing layer 2 to the main controller 6, and the second controller 5 transmits a pressing signal of the piezoelectric sensing layer 4 to the main controller 6, such that the main controller 6 acquires the touching position and the pressure value on the touch screen 1.

It is to be noted that the piezoelectric sensing layer 4 is arranged around four inner sides of the non-window area 12 which surrounds the capacitive sensing layer 2.

In other words, the piezoelectric sensing layer 4 is arranged on each inner side of the non-window area 12 and has four sections which connect together so as to form a closed quadrilateral frame; wherein

the piezoelectric sensing layer 4 is made of Lead Zirconate Titanate (PZT);

a piezoelectric coefficient of the piezoelectric sensing layer 4 is 1000 pC/N;

an electrode of the piezoelectric sensing layer 4 is a double-sided electrode.

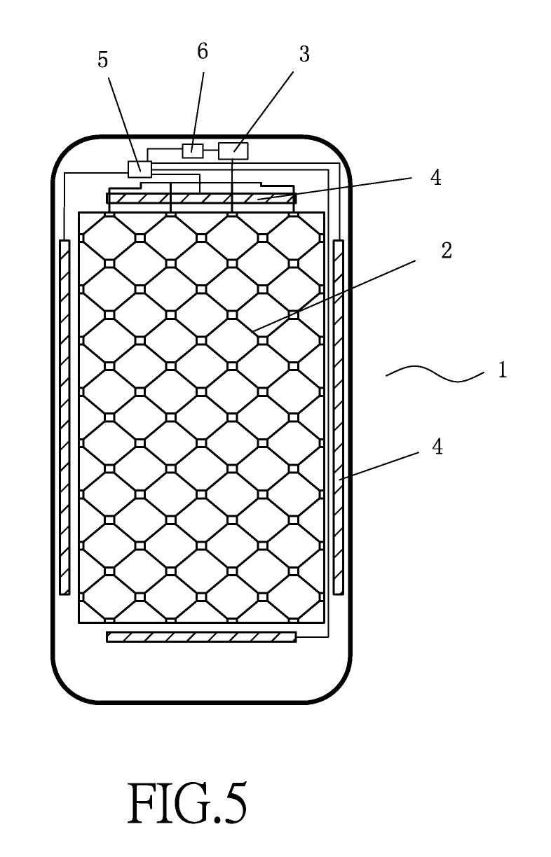

Referring to FIG. 5, a difference of a touch screen 1 of a second embodiment from comprises:

a piezoelectric sensing layer 4 made of Lead Barium Solium Lithium Niobate (PBLN), a piezoelectric coefficient of the piezoelectric sensing layer 4 being 300 pC/N, and an electrode of the piezoelectric sensing layer 4 being a single sided electrode.

In addition, the piezoelectric sensing layer 4 has four sections arranged on four inner side of a non-window area 12 and do not connect together.

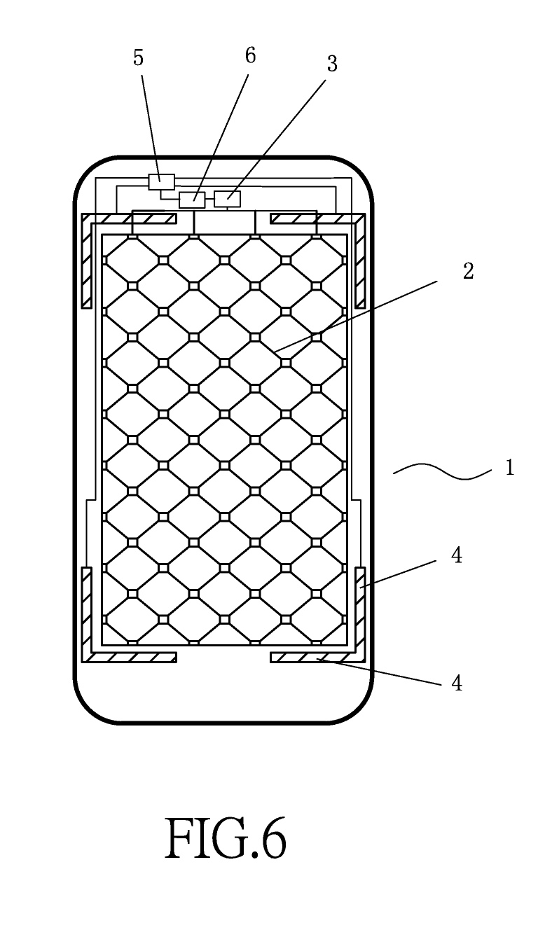

As shown to FIG. 6, a difference of a touch screen 1 of a third embodiment from comprises:

a piezoelectric sensing layer 4 made of Polyvinylidene fluoride (PVDF), a piezoelectric coefficient of the piezoelectric sensing layer 4 being 20 pC/N, and an electrode of the piezoelectric sensing layer 4 being a double-sided electrode.

Also, the piezoelectric sensing layer 4 has eight sections, each two sections are arranged on each of four corners of a non-window area 12 and connect together.

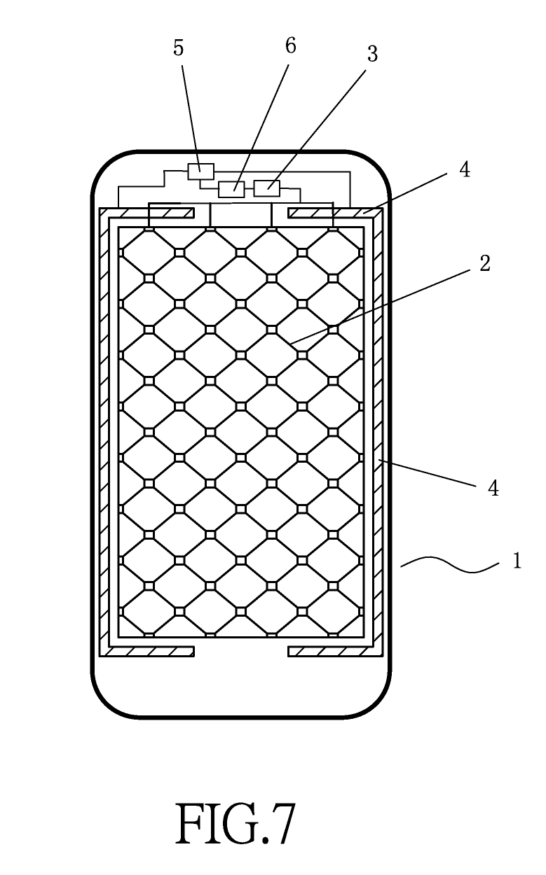

As illustrated to FIG. 7, a difference of a touch screen 1 of a fourth embodiment from comprises:

a piezoelectric sensing layer 4 made of Quartz Crystal (QC), a piezoelectric coefficient of the piezoelectric sensing layer 4 being 120 pC/N, and an electrode of the piezoelectric sensing layer 4 being a single sided electrode.

Also, the piezoelectric sensing layer 4 has two longer sections and four shorter sections, and a non-window area 12 has two longer inner sides and two shorter inner sides, wherein each longer section and each two shorter sections of the piezoelectric sensing layer 4 are connected together and arranged around the two shorter inner sides and one of the two longer inner sides of the non-window area 12, wherein the each longer section of the piezoelectric sensing layer 4 is connected between the each two shorter sections of the piezoelectric sensing layer 4 and arranged on each longer inner side of the non-window area 12.

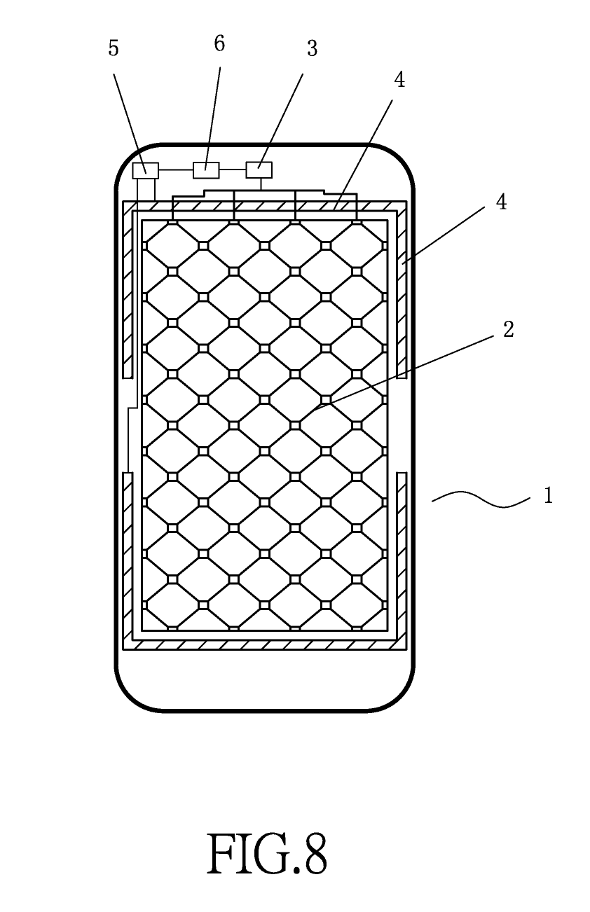

As shown to FIG. 8, a difference of a touch screen 1 of a fifth embodiment from comprises:

a piezoelectric sensing layer 4 made of Lithium Tantalate (LT), a piezoelectric coefficient of the piezoelectric sensing layer 4 being 70 pC/N, and an electrode of the piezoelectric sensing layer 4 being a single sided electrode.

Also, the piezoelectric sensing layer 4 has two longer sections and four shorter sections, and a non-window area 12 has two longer inner sides and two shorter inner sides, wherein each longer section and each two shorter sections of the piezoelectric sensing layer 4 are connected together and arranged around the two longer inner sides and one of the two shorter inner sides of the non-window area 12, wherein the each longer section of the piezoelectric sensing layer 4 is connected between the each two shorter sections of the piezoelectric sensing layer 4 and is arranged on each shorter inner side of the non-window area 12.

Thereby, the piezoelectric sensing layer is applied in the touch screen and its electrical charge is proportional to the pressure value of the touch screen in a vertical direction.

Moreover, a transmittance of the piezoelectric sensing layer is less than 80%, so the piezoelectric sensing layer is arranged in the non-window area of the touch screen, and the capacitive sensing layer is arranged in the window area so as to detect the touching position in X, Y axes, and the piezoelectric sensing layer detects the pressure value on the piezoelectric sensing layer of the touch screen in Y axis, thereafter an electrical charge of a pressure point of the piezoelectric sensing layer and a capacitor sensed by the capacitive sensing layer are inputted into the first controller and the second controller so as to be processed and calculated, wherein the first controller and the second controller allow converting charge voltage and outputting digital signals, such as the touching position. the pressure value, and touch time. Thereafter, the digital signals are transmitted to the main controller from the first controller and the second controller, such that the main controller acquires the touching position and the pressure value on the touch screen, thus obtaining three-dimensional interface control and human-computer interaction based on the pressure value.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A touch screen comprising:
a capacitive sensing layer, a first controller for detecting a touching position on the capacitive sensing layer, a piezoelectric sensing layer, a second controller for detecting a touching pressure on the capacitive sensing layer, and a main controller; wherein
the touch screen also comprises a window area and a non-window area, the capacitive sensing layer is arranged in the window area, the piezoelectric sensing layer is arranged in the non-window area, and the first controller connects with the capacitive sensing layer, the second controller couples with the piezoelectric sensing layer, and the main controller is in connection with the first controller and the second controller, wherein the first controller transmits a touching signal of the capacitive sensing layer to the main controller, and the second controller transmits a pressing signal of the piezoelectric sensing layer to the main controller, such that the main controller acquires the touching position and the pressure value on the touch screen.

2. The touch screen as claimed in claim 1, wherein a piezoelectric coefficient of the piezoelectric sensing layer is within 10 pC/N˜1000 pC/N.

3. The touch screen as claimed in claim 1, wherein the piezoelectric sensing layer is made of any one of Lead Zirconate Titanate (PZT), Lead Barium Solium Lithium Niobate (PBLN), Polyvinylidene fluoride (PVDF), quartz crystal (QC), and Lithium Tantalate (LT).

4. The touch screen as claimed in claim 1, wherein an electrode of the piezoelectric sensing layer is any one of a single sided electrode and double-sided electrode.

5. The touch screen as claimed in claim 1, wherein the piezoelectric sensing layer is arranged around four inner sides of the non-window area which surrounds the capacitive sensing layer and has four sections which connect together so as to form a closed quadrilateral frame

6. The touch screen as claimed in claim 1, wherein the piezoelectric sensing layer has four sections arranged on four inner side of a non-window area and do not connect together.

7. The touch screen as claimed in claim 1, wherein the piezoelectric sensing layer has eight sections, each two sections are arranged on each of four corners of a non-window area and connect together.

8. The touch screen as claimed in claim 1, wherein the piezoelectric sensing layer has two longer sections and four shorter sections, and the non-window area has two longer inner sides and two shorter inner sides, wherein each longer section and each two shorter sections of the piezoelectric sensing layer are connected together and arranged around the two shorter inner sides and one of the two longer inner sides of the non-window area, wherein the each longer section of the piezoelectric sensing layer is connected between the each two shorter sections of the piezoelectric sensing layer and arranged on each longer inner side of the non-window area.

9. The touch screen as claimed in claim 1, wherein the piezoelectric sensing layer has two longer sections and four shorter sections, and the non-window area has two longer inner sides and two shorter inner sides, wherein each longer section and each two shorter sections of the piezoelectric sensing layer are connected together and arranged around the two longer inner sides and one of the two shorter inner sides of the non-window area, wherein the each longer section of the piezoelectric sensing layer is connected between the each two shorter sections of the piezoelectric sensing layer and is arranged on each shorter inner side of the non-window area.
